(19) United States
(12) Patent Application Publication
(10) Pub. No.: US 2015/0180018 A1
(43) Pub. Date: Jun. 25, 2015

(54) METHOD FOR PRODUCING ELECTRODE, AND BATTERY

(71) Applicant: Tomoya Mesuda, Toyota-shi (JP)

(72) Inventor: Tomoya Mesuda, Toyota-shi (JP)

(73) Assignee: TOYOTA JIDOSHA KABUSHIKI KAISHA, Toyota-shi, Aichi (JP)

(21) Appl. No.: 14/408,629

(22) PCT Filed: Jun. 20, 2012
(86) PCT No.: PCT/JP2012/065736

§ 371 Date: Dec. 17, 2014

(51) Int. Cl. H01M 4/04; H01M 10/0525; H01M 4/62

(52) U.S. Cl. CPC H01M 4/0404; H01M 4/62; H01M 10/0525

(57) ABSTRACT

Disclosed is a technique capable of minimizing defects, such as pinholes, in an electrode. A negative electrode forming step includes a mixture preparing step for preparing a paste-like negative electrode mixture containing a negative electrode active material, and an applying step for applying the electrode mixture onto the surface of a sheet-like negative electrode current collector. The mixture preparing step includes the step for adding a solvent to a thickener in powder form and the negative electrode active material. The thickener is carboxymethyl cellulose having a maximum particle size equal to or less than 1/4 of the thickness of the electrode mixture applied onto the negative electrode current collector in the applying step.

### TECHNICAL FIELD

The present invention relates to a method for producing an electrode and to a battery, and particularly to a technique for preparing an electrode mixture.

### BACKGROUND ART

Conventionally, there is a widely known battery (e.g., lithium-ion secondary battery) having an electrode body formed by laminating and winding a pair of sheet-like electrodes (positive and negative electrodes) with separators interposed therebetween.

An electrode for use in such a battery is made through the step for kneading materials, such as an active material, with a solvent to prepare a paste-like electrode mixture, the step for applying the prepared electrode mixture onto the surface of a sheet-like current collector, and the like.

The electrode mixture is prepared by appropriately adding a thickener such as carboxymethyl cellulose (CMC) to the active material.

When added to the active material, the thickener is generally dissolved in water. In this case, aggregates (microgels) are formed in an aqueous solution of the thickener. When such an aqueous solution in which microgels remain is used to form an electrode, defects such as pinholes may occur in the electrode mixture of the electrode. Therefore, treatment for removing the microgels (e.g., filtration) needs to be performed. However, performing the treatment for removing the microgels is disadvantageous in that it takes more time and cost to form the electrode,

On the other hand, a technique intended to reduce time and cost required to form an electrode is also known in which a thickener is added not in the form of aqueous solution but in the form of powder to an active material, and the resulting mixture is kneaded with a solvent to prepare an electrode mixture.

However, even when the electrode is formed using the electrode mixture prepared by such a technique, microgels may be formed in the electrode mixture, and consequently defects such as pinholes may occur in the electrode mixture of the electrode.

Patent Literature 1 discloses a technique for suppressing the formation of microgels by adjusting the ratio between the particle size of an active material and the particle size of a thickener.

However, as shown in FIG. 4(a), the particle size of a microgel is approximately three times as large as that of a thickener, and therefore, depending on the thickness (vertical size in FIG. 4(a)) of an electrode mixture applied onto a current collector, the microgel is exposed from the surface of the electrode mixture. When the electrode mixture is dried, the microgel is turned into powder due to evaporation of moisture thereof. As a result, as shown in FIG. 4(b), a recess is formed in a position where the microgel was present in the electrode mixture.

A Portion of the electrode mixture where the recess has been formed finally causes defects such as pinholes. Consequently, the current collector is generally exposed at portions of the electrode where defects, such as pinholes, have occurred. Therefore, if a battery having such an electrode is used, a problem, such as deposition of dendrites, may occur.

### CITATION LIST

### Patent Literature

Patent Literature 1: JP 2011-63673 A

### SUMMARY OF INVENTION

### Problem to Be Solved By the Invention

The objective of the present invention is to provide a technique capable of minimizing defects, such as pinholes, in an electrode.

### Means for Solving the Problem

A first aspect of the present invention is a method for producing an electrode, including a mixture preparing step for preparing a paste-like electrode mixture containing an active material, and an applying step for applying the electrode mixture onto a surface of a sheet-like. current collector. The mixture preparing step includes a step for adding a solvent to a thickener in powder form and the active material. The thickener is carboxymethyl cellulose having a maximum particle size equal to or less than ¼ of a thickness of the electrode mixture applied onto the current collector in the applying step.

Preferably, the thickener has a degree of etherification of 0.65 or more.

Preferably, the solvent is an aqueous solvent.

A second aspect of the present invention is a battery including an electrode produced by the method for producing an electrode.

### EFFECTS OF THE INVENTION

The present invention makes it possible to minimize defects, such as pinholes, in an electrode.

### BRIEF DESCRIPTION OF DRAWINGS

FIG. 1 shows a process of producing a negative electrode according to an embodiment of the present invention.

FIG. 2 shows a step for producing the negative electrode according to the embodiment of the present invention.

FIG. 3(a) shows a microgel formed in a negative electrode mixture, and FIG. 3(b) shows a pore formed in the dried negative electrode mixture.

FIG. 4(a) shows a microgel exposed from the surface of an electrode mixture, and FIG. 4(b) shows a recess formed in the surface of the dried electrode mixture.

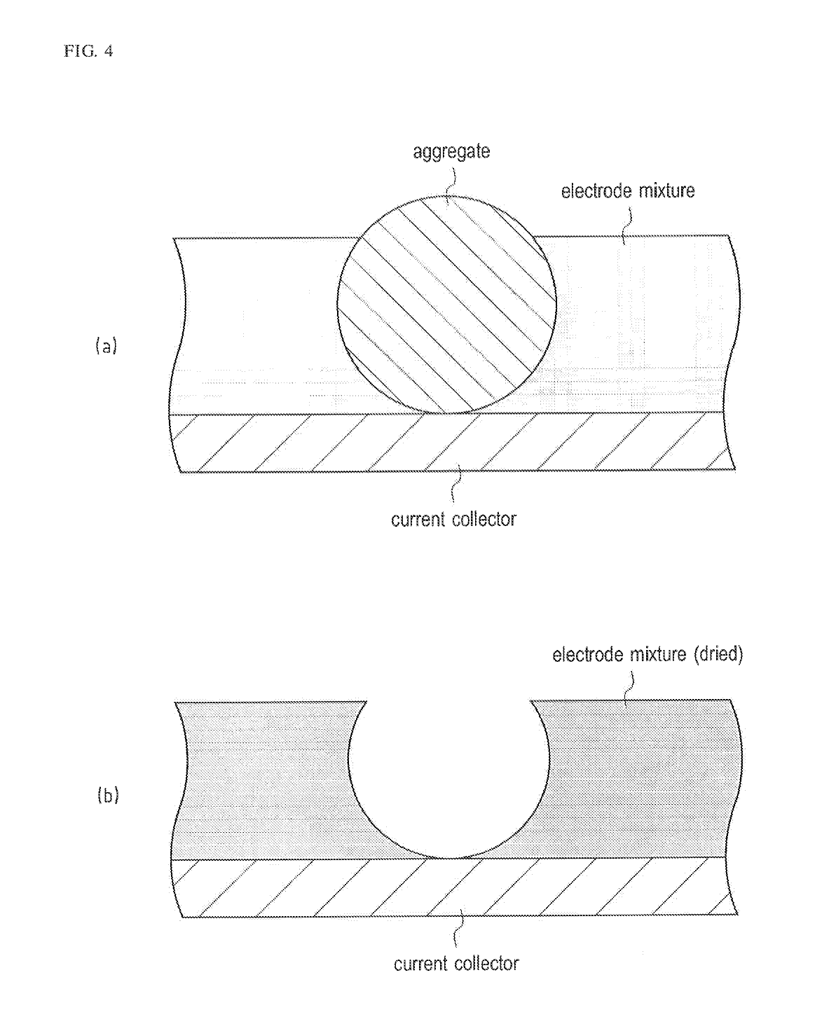

### DESCRIPTION OF EMBODIMENTS

A lithium-ion secondary battery as an embodiment of a battery according to the present invention is described below.

The lithium-ion secondary battery includes a case as an exterior thereof, and an electrode body stored in the case.

The case is a container made of aluminum, stainless steel or the like. The electrode body is stored together with an electrolyte solution in the case.

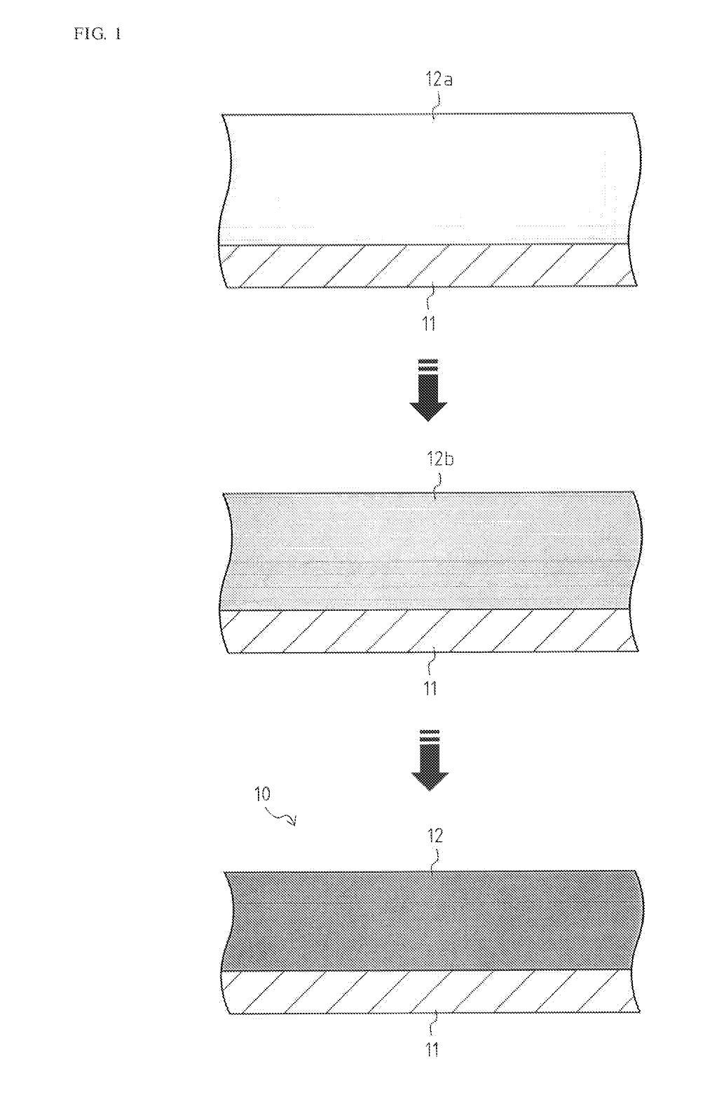

The electrode body is formed by laminating and winding a positive electrode and a negative electrode 10 (see FIG. 1) with separators interposed therebetween. The electrode body is impregnated with the electrolyte solution so as to function as a power-generating element.

The positive electrode is an electrode including a sheet-like positive electrode current collector, and a positive electrode mixture layer formed on the surface of the positive electrode current collector.

The positive electrode current collector is a current collector including a metal foil of aluminum, titanium, stainless steel or the like.

The positive electrode mixture layer is an electrode mixture layer including a positive electrode mixture containing a positive electrode active material, a conductive auxiliary agent, a binder and the like.

As shown in FIG. 1, the negative electrode 10 is an electrode including a sheet-like negative electrode current collector 11, and a negative electrode mixture layer 12 formed on the surface of the negative electrode current collector 11.

The negative electrode current collector 11 is a current collector including a metal foil of copper, nickel, stainless steel or the like.

The negative electrode mixture layer 12 is an electrode mixture layer including a negative electrode mixture 12a containing a negative electrode active material, a thickener, a binder and the like. The negative electrode mixture layer 12 is formed by drying the paste-like negative electrode mixture 12a applied onto the surface of the negative electrode current collector 11 by an applicator such as a die coater, and then pressing a dried negative electrode mixture (hereinafter, referred to as a “dry mixture”) 12b.

The separator is an insulator made of a polyolefin resin (e.g., polyethylene, polypropylene) or the like. The separators are interposed between the positive electrode and the negative electrode 10.

A step for producing the above-mentioned lithium-ion secondary battery is described below.

The step for producing the lithium-ion secondary battery includes a positive electrode forming step for forming the positive electrode and a negative electrode forming step S10 for forming the negative electrode 10.

First, in the positive electrode forming step, the positive electrode active material is dispersed together with the conductive auxiliary agent, the binder and the like in a solvent with the use of a kneader such as a twin-screw kneader or a planetary mixer to prepare the paste-like positive electrode mixture.

Next, the positive electrode mixture is applied in the form of a layer onto the surface of the positive electrode current collector with the use of an applicator such as a die coater and is then dried.

Finally, the dried positive electrode mixture on the positive electrode current collector is pressed by a roll pressing machine or the like to form the positive electrode mixture layer on the surface of the positive electrode current collector.

The negative electrode forming step S10 is an embodiment of a method for producing an electrode according to the present invention.

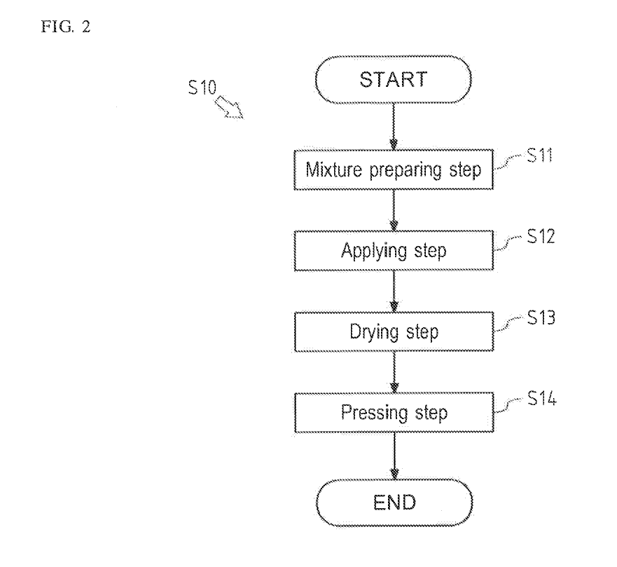

As shown in FIG. 2, the negative electrode forming step S10 includes a mixture preparing step S11 for preparing the negative electrode mixture 12a containing a negative electrode active material, an applying step S12 for applying the negative electrode mixture 12a onto the surface of the negative electrode current collector 11, a drying step S13 for drying the negative electrode mixture 12a applied onto the surface of the negative electrode current collector 11 to prepare the dry mixture 12b, and a pressing step S14 for pressing the dry mixture 12b on the negative electrode current collector 11 to form the negative electrode mixture layer 12.

The mixture preparing step S11 is a step for preparing the negative electrode mixture 12a using a negative electrode active material, a thickener, a binder, a binder, and a solvent.

The mixture preparing step S11 includes a step for adding the solvent to the thickener in powder form and the negative electrode active material, and a step for kneading the thickener, the negative electrode active material, the solvent and the binder.

In the mixture preparing step S11, the thickener in powder form and the negative electrode active material are fed into a kneader, and the solvent is also fed into the kneader to knead them. Then, the binder is fed into the kneader, and the resulting mixture is further kneaded to prepare the paste-like negative electrode mixture 12a,

At this time, these materials are preferably fed into the kneader at a ratio of negative electrode active material thickener : binder of 98 to 98.5:0.5 to 2.0:1.0 (wt %).

In the present embodiment, the thickener is fed in powder form into a kneader together with the negative electrode active material and the solvent, but the thickener in powder form may be mixed with the negative electrode active material before they are fed into a kneader.

The solid content of the negative electrode mixture 12a prepared in the mixture preparing step S11 is preferably approximately 40 to 60%. However, the solid content of the negative electrode mixture 12a may be approximately 80% as long as the negative electrode mixture 12a can be suitably applied onto the negative electrode current collector 11 in the applying step S12.

In the mixture preparing step S11, the solvent may be fed into the kneader in several batches to adjust the solid content of the negative electrode mixture 12a to a desired value. For example, the negative electrode mixture 12a with a desired solid content may he prepared by adding a relatively small amount of solvent to the negative electrode active material and the thickener to knead them, and then adding a predetermined amount of solvent to the mixture to further knead them.

As the negative electrode active material, a carbon-based material such as graphite may be used.

As the solvent, an aqueous solvent such as ion-exchange water or distilled water may be used. Note that the aqueous solvent is a solvent consisting primarily of water.

As the binder, polyvinylidene fluoride (PVdF), methylcellulose (MC), carboxymethyl cellulose (CMC), hydroxypropyl cellulose (HPC), polyvinyl butyral (PVB), polyethylene (PE), polyvinyl alcohol (PVA), polytetrafluoroethylene (PTFE), styrene-butadiene rubber (SBR) or the like may be used.

As the thickener, carboxymethyl cellulose (CMC) is used.

The maximum particle deameter (D100 in particle-size distribution) of CMC as the thickener is set to be equal to or less than ¼ of the thickness of the negative electrode mixture 12a applied onto the negative electrode current collector 11.

CMC having a particle size satisfying such a requirement may be obtained by, for example, pulverization treatment. Specifically, CMC may be pulverized using a predetermined pulverizer so as to have a particle size satisfying the above requirement. Alternatively, existing CMC having a particle size satisfying the above requirement may be used without performing pulverization treatment.

Note that the “thickness” of the negative electrode mixture 12a refers to the shortest distance from the surface of the negative electrode mixture 12a, applied onto the negative electrode current collector 11, in contact with the negative electrode current collector 11 to the surface of the negative electrode mixture 12a substantially parallel to the contact surface (vertical size of the negative electrode mixture 12a in FIG. 1). In particular, the thickness of the negative electrode mixture 12a applied onto the negative electrode current collector 11 means the thickness of the negative electrode mixture 12a applied onto the negative electrode current collector 11 in the applying step S12 following the mixture preparing step S11.

In the applying step S12, the negative electrode mixture 12a is applied onto the surface of the negative electrode current collector 11 using an applicator such as a die coater.

In the drying step S13, the negative electrode mixture 12a applied onto the surface of the negative electrode current collector 11 is dried in a drying furnace or the like to prepare the dry mixture 12b.

As mentioned previously, CMC for use in preparing the negative electrode mixture 12a has a maximum particle size (D100 in particle-size distribution) equal to or less than ¼ of the thickness of the negative electrode mixture 12a applied onto the negative electrode current collector 11.

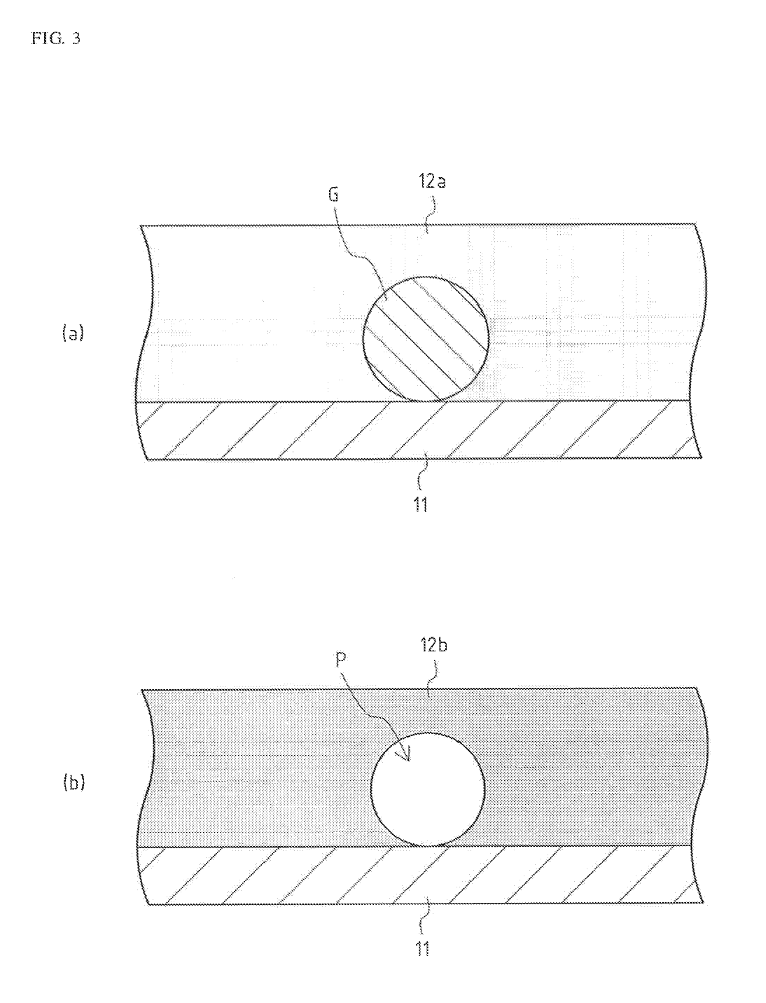

Therefore, as shown in FIG. 3(a), even when microgels Gas aggregates are present in the negative electrode mixture 12a, an increase in the particle size of the microgels G is suppressed, which makes it possible to suppress the exposure of the microgels G from the surface of the negative electrode mixture 12a applied onto the negative electrode current collector 11.

As a result, as shown in FIG. 3(b), when the negative electrode mixture 12a is dried, pores P are formed in positions where the microgels G were present in the dry mixture 12b, but formation of recesses on the surface of the dry mixture 12b can be suppressed.

Therefore, detects, such as pinholes, in the negative electrode 10 can be minimized, which makes it possible to suppress a reduction in the performance of the lithium-ion secondary battery.

Moreover, the step of removing the microgels G does not need to he performed separately, which makes it possible to reduce time and cost required to form the negative electrode 10.

Making the particle size of CMC smaller can make the particle size of the microgels G smaller. In addition, making the particle size of CMC smaller can improve solubility of CMC into the solvent, thus enabling to suppress the formation of the microgels G. However, if CMC has an extremely small particle size, it is difficult to handle CMC. For this reason, the particle size of CMC is preferably adjusted to a level (e.g., 25 μm) at which CMC can be handled without difficulty.

Moreover, CMC for use in preparing the negative electrode mixture 12a preferably has a degree of etherification of 0.65 or more.

Note that the “degree of etherification” of CMC is the number of hydroxyl groups substituted by ether groups (carboxymethyl groups) per glucose unit containing three hydroxyl groups and constituting cellulose.

Generally, making the degree of etherification of CMC results in high solubility of CMC into the solvent, which makes it possible to suppress the formation of the microgels G. Therefore, it is considered that if the degree of etherification of CMC is set to a theoretical maximum value of 3, the formation of the microgels G can be prevented, and consequently the formation of recesses in the dry mixture 12 can be prevented, However, this is actually difficult. In other words, it is actually difficult to completely prevent the formation of the microgels G.

However, the number of the microgels G in the negative electrode mixture 12a can be reduced to some degree by setting the degree of etherification of CMC for use in preparing the negative electrode mixture 12a to 0.65 or more. The number of the pores P in the dry mixture 12b is also reduced by reducing the number of the microgels G in the negative electrode mixture 12a, which makes it possible to minimize the adverse effect caused by formation of a large number of the pores P in the dry mixture 12b (e.g., a reduction in the thickness of the dry mixture 12b).

Therefore, defects in the dry mixture 12b can further be minimized by, in addition to adjusting the particle size of CMC in such a manner as mentioned above, setting the degree of etherification of CMC for use in preparing the negative electrode mixture 12a to 0.65 or more to suppress the formation of the microgels G to some degree.

The larger the degree of etherification of CMC is, the higher the price of CMC is. For this reason, CMC having a relatively low degree of etherification is preferably used as long as the formation of the microgels G can be suppressed.

In the pressing step S14, the dry mixture 12b on the negative electrode current collector 11 is pressed by, for example, a roll pressing machine to form the negative electrode mixture layer 12. In other words, the negative electrode mixture layer 12 is formed on the surface of the negative electrode current collector 11.

At this time, even when remaining in the dry mixture 12b, the pores P hardly remain in the finally formed negative electrode mixture layer 12 because the dry mixture 12b is compressed by pressing. In other words, as mentioned previously, the performance of the finally formed negative electrode 10 is not significantly affected as long as the particle size of CMC is adjusted so that the microgels C are not exposed front the surface of the negative electrode mixture 12a applied onto the negative electrode current collector 11.

As mentioned above, in the negative electrode forming step S10, the negative electrode 10 is formed through the mixture preparing step S11, the applying step S12, the drying step S13, and the pressing step S14 in this order.

After the positive electrode forming step and the negative electrode forming step S10, the lithium-ion secondary battery is produced through the step for forming the electrode body using the positive electrode and the negative electrode 10, the step for storing the electrode body in the case, the step for pouring the electrolyte solution into the case accommodating the electrode body, and the like.

In the present embodiment, the negative electrode 10 is formed using CMC whose maximum particle size (D100 in particle-size distribution) is equal to or less than ¼ of the thickness of the negative electrode mixture 12a applied onto the negative electrode current collector 11 (negative electrode forming step S10), but the positive electrode may also he formed using a thickener whose particle size is adjusted in the same manner.

In this case, the positive electrode forming step for forming the positive electrode has the same effect as the negative electrode forming step S10 for forming the negative electrode 10. Specifically, it is possible to minimize defects, such as pinholes, in the positive electrode.

The characteristics of a negative electrode mixture for use in forming a negative electrode according to the present invention is described below, based on Examples 1 to 7 and Comparative Examples 1 and 2.

Specifically, described is the state of a dried negative electrode mixture (dry mixture) prepared by drying a negative electrode mixture applied onto a negative electrode current collector.

### Example 1

As a thickener, carboxymethyl cellulose (CMC) having a maximum particle size of 21 μm and a degree of etherification of 0.65 was used.

Moreover, graphite, styrene-butadiene rubber (SBR), and ion-exchange water were used as a negative electrode active material, a binder, and a solvent, respectively.

First, the thickener in powder form was fed into a twin-screw kneader (rotation speed: 600 rpm) together with the negative electrode active material and the solvent, and the resulting mixture was kneaded to prepare a paste having a solid content of 65%. Then, after the paste was kneaded with the solvent further added, the paste was further kneaded with the binder added to prepare a negative electrode mixture having a solid content of 54%. At this time, these materials were fed into the twin-screw kneader at a ratio of negative electrode active material : thickener : binder of 98.3:0.7:1.0 (wt %),

Then, after the prepared negative electrode mixture was applied onto the surface of a negative electrode current collector so as to have a thickness of 100 μm, the applied negative electrode mixture was dried to prepare a dry mixture.

### Example 2

A negative electrode mixture was prepared in the same manner as in Example 1 except that carboxymethyl cellulose (CMC) having a maximum particle size of 25 μm was used as a thickener. Then, after the prepared negative electrode mixture was applied onto the surface of a negative electrode current collector in the same manner as in Example 1, the applied negative electrode mixture was dried to prepare a dry mixture.

### Example 3

A negative electrode mixture was prepared in the same manner as in Example 1 except that carboxymethyl cellulose (CMC) having a maximum particle size of 10 μm was used as a thickener. Then, after the prepared negative electrode mixture was applied onto the surface of a negative electrode current collector so as to have a thickness of 80 μm, the applied negative electrode mixture was dried to prepare a dry mixture.

### Example 4

A negative electrode mixture was prepared in the same manner as in Example 1 except that carboxymethyl cellulose (CMC) having a maximum particle size of 15 μm was used as a thickener. Then, after the prepared negative electrode mixture was applied onto the surface of a negative electrode current collector so as to have a thickness of 80 μm, the applied negative electrode mixture was dried to prepare a dry mixture.

### Example 5

A negative electrode mixture was prepared in the same manner as in Example 1 except that carboxymethyl cellulose (CMC) having a maximum particle size of 6 μm. was used as a thickener. Then, after the prepared negative electrode mixture was applied onto the surface of a negative electrode current collector so as to have a thickness of 60 μm, the applied negative electrode mixture was dried to prepare a dry mixture.

### Example 6

A negative electrode mixture was prepared in the same manner as in Example 1 except that carboxymethyl cellulose (CMC) having a maximum particle size of 1.0 μm was used as a thickener. Then, after the prepared negative electrode mixture was applied onto the surface of a negative electrode current collector so as to have a thickness of 60 μm, the applied negative electrode mixture was dried to prepare a dry mixture.

### Example 7

A negative electrode mixture was prepared in the same manner as in Example 1 except that carboxymethyl cellulose (CMC) having a maximum particle size of 15 μm was used as a thickener. Then, after the prepared negative electrode mixture was applied onto the surface of a negative electrode current collector so as to have a thickness of 60 μm, the applied negative electrode mixture was dried to prepare a dry mixture.

### Comparative Example 1

A negative electrode mixture was prepared in the same manner as in Example 1 except that carboxymethyl cellulose (CMC) having a maximum particle size of 30 μm was used as a thickener. Then, after the prepared negative electrode mixture was applied onto the surface of a negative electrode current collector in the same manner as in Example 1, the applied negative electrode mixture was dried to prepare a dry mixture.

### Comparative Example 2

A negative electrode mixture was prepared in the same manner as in Example 1 except that carboxymethyl cellulose (CMC) having a maximum particle size of 21 μm was used as a thickener. Then, after the prepared negative electrode mixture was applied onto the surface of a negative electrode current collector so as to have a thickness of 80 μm, the applied negative electrode mixture was dried to prepare a dry mixture.

A recess with a diameter of 0.3 mm or more formed in each of the dry mixtures prepared in Examples 1 to 7 and Comparative Examples 1 and 2 was defined as a defect, and the number of the defects per 100 cm² of each of the dry mixtures was counted.

The following Table 1 shows the number of the defects of each of the dry mixtures prepared in Examples 1 to 7 and Comparative Examples 1 and 2.

TABLE 1

| | Maximum | | Thickness of | |
|---|---|---|---|---|
| | particle | Maximum | negative | Number of |
| | size of | particle size of | electrode | defects [per |
| | CMC [μm] | microgel [μm] | mixture [μm] | 100 cm²] |
| Example 1 | 21 | 64 | 100 | 0 |
| Example 2 | 25 | 78 | 100 | 0 |
| Example 3 | 10 | 32 | 80 | 0 |
| Example 4 | 15 | 45 | 80 | 0 |
| Example 5 | 6 | 19 | 60 | 0 |
| Example 6 | 10 | 32 | 60 | 0 |
| Example 7 | 15 | 45 | 60 | 0 |
| Comparative | 30 | 95 | 100 | 20 |
| Example 1 | | | | |
| Comparative | 21 | 64 | 80 | 0 |
| Example 2 | | | | |

No defects were detected in all the dry mixtures prepared in Examples 1 to 7.

This is because in each of Examples 1 to 7, the maximum particle size of CMC as a thickener was equal to or less than ¼ of the thickness of the negative electrode mixture applied onto the negative electrode current collector, and the maximum particle size of microgels formed in the negative electrode mixture was sufficiently smaller than the thickness of the negative electrode mixture. Specifically, this is because the maximum particle size of microgels formed in the negative electrode mixture was sufficiently smaller than the thickness of the negative electrode mixture, and microgels exposed from the surface of the negative electrode mixture were hardly formed.

In Comparative Example 1, 20 defects were detected per 100 cm² of the dry mixture.

This is because the maximum particle size (30 μm) of CMC as a thickener was more than ¼ of the thickness (100 μm) of the negative electrode mixture applied onto the negative electrode current collector, and there was substantially no difference between the maximum particle size (95 μm) microgels formed in the negative electrode mixture and the thickness of the negative electrode mixture (100 μm). Specifically, this is because there was substantially no difference between the maximum particle size of microgels formed in the negative electrode mixture and the thickness of the negative electrode mixture, and a large number of microgels exposed from the surface of the negative electrode mixture were formed.

In Comparative Example 2, no defects were detected in the dry mixture in spite of the fact that the maximum particle size (21 μm) of CMC as a thickener was more than ¼ of the thickness (80 μm) of the negative electrode mixture applied onto the negative electrode current collector,

The reason for this is considered to be that the difference between the maximum particle size (21 μm) of CMC as a thickener and a value (20 μm) equal to ¼ of the thickness (80 μm) of the negative electrode mixture applied onto the negative electrode current collector was only 1 μm.

Moreover, in Comparative Example 2, recesses with a diameter of 0.3 mm or more were not formed, but a large number of recesses with a diameter of less than 0.3 mm were considered to be formed.

As mentioned above, it was found that the negative electrode mixture for use in forming the negative electrode according to the present invention has excellent properties when the maximum particle size of CMC as a thickener is equal to or less than ¼ of the thickness of the negative electrode mixture applied onto the negative electrode current collector.

In Comparative Example 2, no defects were detected in the dry mixture, but the maximum particle size of CMC as a thickener is preferably equal to or less than ¼ of the thickness of the negative electrode mixture applied onto the negative electrode current collector in order to more reliably minimize the defects.

### INDUSTRIAL APPLICABILITY

The present invention is applied to a method for producing an electrode, and to a battery.

### REFERENCE SIGNS LIST

10: negative electrode
11.: negative electrode current collector
12: negative electrode mixture layer
12a: negative electrode mixture
12b: dry mixture

1. A method for producing an electrode, comprising:
a mixture preparing step for preparing a paste-like electrode mixture containing an active material; and
an applying step for applying the electrode mixture onto a surface of a sheet-like current collector,
wherein the mixture preparing step includes a step for adding a solvent to a thickener in powder form and the active material, and
wherein the thickener is carboxymethyl cellulose having a maximum particle size equal to or less than ¼ of a thickness of the electrode mixture applied onto the current collector in the applying step, and
wherein the thickener has a degree of etherification of 0.65 or more.

2. (canceled)

3. The method according to claim 1, wherein the solvent is an aqueous solvent.

4. A battery comprising an electrode produced by the method for producing an electrode according to claim 1.

5. A battery comprising an electrode produced by the method for producing an electrode according to claim 3.
